(19) United States
(12) Patent Application Publication
(10) Pub. No.: US 2007/0273220 A1
(43) Pub. Date: Nov. 29, 2007

(54) APPARATUS FOR CONTROLLER-INTEGRATED MOTOR

(76) Inventors: Taihei KOYAMA, Fuchu-shi (JP); Shinichi Noda, Kawasaki-shi (JP); Kenzo Tonoki, Tokyo (JP); Shigetomo Shiraishi, Fuchu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/746,876

(22) Filed: May 10, 2007

(30) Foreign Application Priority Data
May 12, 2006 (JP) 2006-134084

(51) Int. Cl. H02K 9/00; H02K 9/06; H02K 3/24

(52) U.S. Cl. 310/58; 310/62; 310/64; 310/89

(57) ABSTRACT

A controller-integrated motor includes a motor main body and a controller integrated with the motor main body to control the motor main body, the motor main body, including a stator core, a shaft which rotates to exert driving force on the motor main body, a frame which holds the stator core and the shaft, and an outer fan provided around the shaft so that the motor main body is recessed inward toward a rotational center of the shaft, the outer fan discharging cooling air stream to cool the motor main body, the controller being provided in proximity to an outer periphery of the frame, the motor main body being formed so that a cooling air stream from the outer fan flows in an axial direction of the shaft along an outer peripheral surface of the frame.

### CROSS-REFERENCE TO RELATED APPLICATIONS

This application is based upon and claims the benefit of priority from prior Japanese Patent Application No. 2006-134084, filed May 12, 2006, the entire contents of which are incorporated herein by reference.

### BACKGROUND OF THE INVENTION

1. Field of the Invention

The present invention relates to a controller-integrated motor includes a motor mainly used to drive a vehicle and a controller integrated with the motor to control the motor.

2. Description of the Related Art

Traction motors for vehicles are subjected to a temperature rise in each of their sections while the vehicle is in motion. The temperature rise is caused by a copper loss in stator and rotator windings, an iron loss in the stator, and other mechanical losses. The traction motor commonly uses the following scheme to cool itself. There is provided a blower that takes in external air to forcibly discharge an air stream into the motor. A fan is provided in the motor and rotated to circulate a cooling air stream through the motor. However, this traction motor is configured so that its interior is in communication with the exterior (open type traction motor). Consequently, dust may enter the motor, resulting in the need for periodic maintenance. Thus, in recent years, fully enclosed type traction motors with outer fans have been developed which have an enclosed traction motor main body and which discharge an air stream onto an outer peripheral surface of the main body for cooling. However, fully enclosed type traction motors with outer fans achieve a lower cooling efficiency than open type traction motors. Thus, the open type traction motor needs to be large in size in order to provide high power.

The traction motor is mounted in a narrow space under a bogie located below a vehicle body. This prevents an increase in the size of the traction motor. Further, the traction motor has been desired to be smaller and lighter. Moreover, proposal has been made of a future traction motor having a controller comprises an inverter or the like and a traction motor integrated with the controller (this traction motor is hereinafter referred to as a “controller-integrated motor”) (Jpn. Pat. Appln. KOKAI Publication No. 2004-312960). In general, the traction motor and the controller are separately located. For example, the traction motor is located in the bogie. On the other hand, the controller is located under a floor of the vehicle. This integration has the following advantages.

The controller and the traction motor are connected together by a cable. Thus, installing the controller and the traction motor close to each other enables a reduction in the length and number of wires. This is expected to reduce costs and to improve reliability. Using a permanent-magnet synchronous motor as a traction motor requires one controller for each traction motor. In this case, the controllers control the respective traction motors. Further, the controllers have a reduced size. Consequently, the controller-integrated motor serves to reduce total costs compared to the separately provided traction motor and controller. The space under the floor occupied by the controller also becomes free. This enables the free under-floor space to be effectively used. Thus, the controller-integrated motor has various advantages.

However, a further reduction is required to accommodate the controller and the traction motor in the bogie. Moreover, since both the controller and traction motor generate heat, sufficient cooling is required to prevent possible overheating. The fully enclosed type traction motor with the outer fan is limited in cooling capability even if the traction motor is separated from the controller. Accordingly, simultaneously cooling the controller requires efficient cooling. Thus, for the controller-integrated motor, various cooling methods have been proposed. These cooling methods are mostly based on an air cooling scheme. For automobiles, the controller-integrated motor has been put to practical use.

FIG. 17 is a vertical sectional view showing a conventional controller-integrated motor. The motor is operated to rotate a shaft 1. Rotation of the shaft 1 rotates an outer fan 4. The rotation of the outer fan 4 has a fan effect to discharge a cooling air stream 30 in a radial direction. The discharged cooling air stream 30 flows around a controller 13. The cooling air stream 30 improves the thermal conductivity of the surface of the controller 13. The controller 13 is thus cooled.

However, a cooling structure in the above conventional controller-integrated motor has the following problems to be solved.

In this motor, the outer fan 4 and the controller 13 are installed side by side in an axial direction. This increases the length of the motor in the axial direction. In general, the axial direction of the motor coincides with the width direction of railway vehicles. The railway vehicle is narrow in the width direction, limiting the space in which the motor can be installed. Consequently, this motor reduces the degree of the freedom with which a motor installation position in the vehicle can be selected.

Further, an air stream from the outer fan 4 is mostly used to cool the controller 13. This brings the motor main body into a state close to natural air cooling. This configuration allows cooling to be achieved only by natural convection when the motor generates less heat. However, the increased capacity of the motor may prevent cooling from being achieved only by natural convection.

### BRIEF SUMMARY OF THE INVENTION

An object of the present invention is to provide a controller-integrated motor provided in a vehicle and which enables a reduction in the axial width of a shaft and an increase in cooling efficiency for the motor main body and the controller.

A controller-integrated motor includes a motor main body and a controller integrated with the motor main body to control the motor main body, the motor main body, including a stator core, shaft which rotates to exert driving force on the motor main body, a frame which holds the stator core and the shaft, and an outer fan provided around the shaft so that the motor main body is recessed inward toward a rotational center of the shaft, the outer fan discharging cooling air stream to cool the motor main body, the controller being provided in proximity to an outer periphery of the frame, the motor main body being formed so that so that a cooling air stream from the outer fan flows in an axial direction of the shaft along an outer peripheral surface of the frame.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a vertical sectional view of a controller-integrated motor in accordance with a first embodiment of the present invention;

FIG. 2 is a sectional view of an unloaded side of the controller-integrated motor in accordance with the first embodiment of the present invention;

FIG. 3 is a vertical sectional view of a controller-integrated motor in accordance with a second embodiment of the present invention;

FIG. 4 is a sectional view of an unloaded side of the controller-integrated motor in accordance with the second embodiment of the present invention;

FIG. 5 is a perspective view of a controller constituting a controller-integrated motor in accordance with a third embodiment of the present invention;

FIG. 6 is a perspective view of a controller constituting a controller-integrated motor in accordance with a fourth embodiment of the present invention;

FIG. 7 is a perspective view of a controller constituting a controller-integrated motor in accordance with a fifth embodiment of the present invention;

FIG. 8 is a vertical sectional view of a controller-integrated motor in accordance with a sixth embodiment of the present invention;

FIG. 9 is a sectional view of an unloaded side of the controller-integrated motor in accordance with the sixth embodiment of the present invention;

FIG. 10 is a vertical sectional view of a controller-integrated motor in accordance with a seventh embodiment of the present invention;

FIG. 11 is a sectional view of an unloaded side of the controller-integrated motor in accordance with the seventh embodiment of the present invention;

FIG. 12 is a vertical sectional view of a controller-integrated motor in accordance with an eighth embodiment of the present invention;

FIG. 13 is a sectional view of an unloaded side of the controller-integrated motor in accordance with the eighth embodiment of the present invention;

FIG. 14 is a vertical sectional view of a controller-integrated motor in accordance with a ninth embodiment of the present invention;

FIG. 15 is a sectional view of an unloaded side of the controller-integrated motor in accordance with the ninth embodiment of the present invention;

FIG. 16 is a perspective view of a controller constituting a controller-integrated motor in accordance with a tenth embodiment of the present invention; and

FIG. 17 is a vertical sectional view of a conventional controller-integrated motor.

### DETAILED DESCRIPTION OF THE INVENTION

Embodiments of the present invention will be described with reference to the drawings.

### First Embodiment

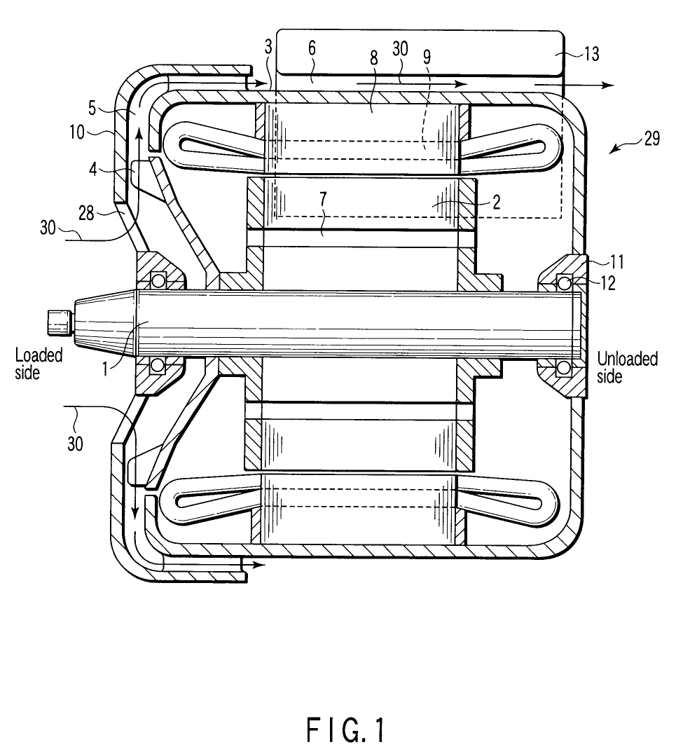

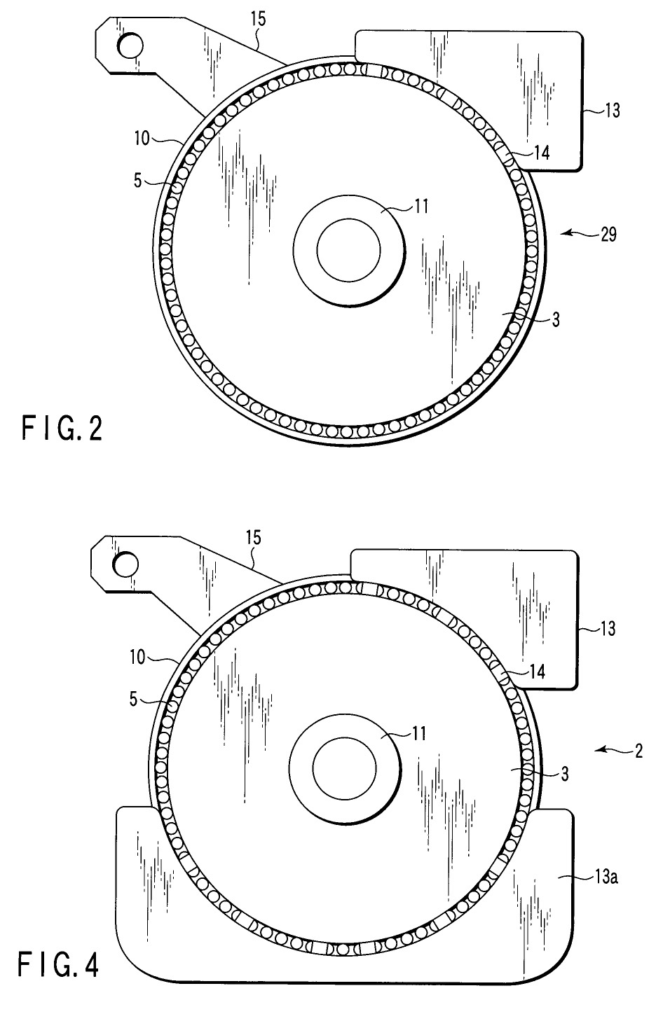

FIG. 1 is a vertical sectional view of a controller-integrated motor in accordance with a first embodiment of the present invention. FIG. 2 is a sectional view of an unloaded side of the controller-integrated motor in accordance with the first embodiment of the present invention. The same components in FIGS. 17, 1, and 2 are denoted by the same reference numerals and will not be described in detail. Different components will be mainly described. Duplicate descriptions are also omitted in the subsequent embodiments.

The present controller-integrated motor comprises a motor main body 29 and a controller 13 mounted on the motor main body 29. The motor main body 29 comprises a frame 3, an end plate 10, a stator core 8, a stator coil 9, a rotor core 2, a shaft 1 that rotates to exert driving force on the motor main body 29, and an outer fan 4 that discharges a cooling air stream 30 to cool the motor main body 29.

In the motor main body 29, the outer fan 4 is fittingly mounted around the shaft 1 on a loaded side which is close to a load of the shaft. The outer fan 4 is provided so that the motor main body 29 is recessed inward toward a rotational center of the shaft 1. The outer fan 4 and the frame 3 are separated from each other with only a small gap between them. This prevents dust from entering the motor main body 29 even when the outer fan 4 rotates. The end plate 10 covers parts of the outer fan 4 and frame 3. This forms a cooling fan guiding duct 5 between the frame 3 and the end plate 10. A vent hole 28 is formed close to the center of the end plate 10 in its radial direction.

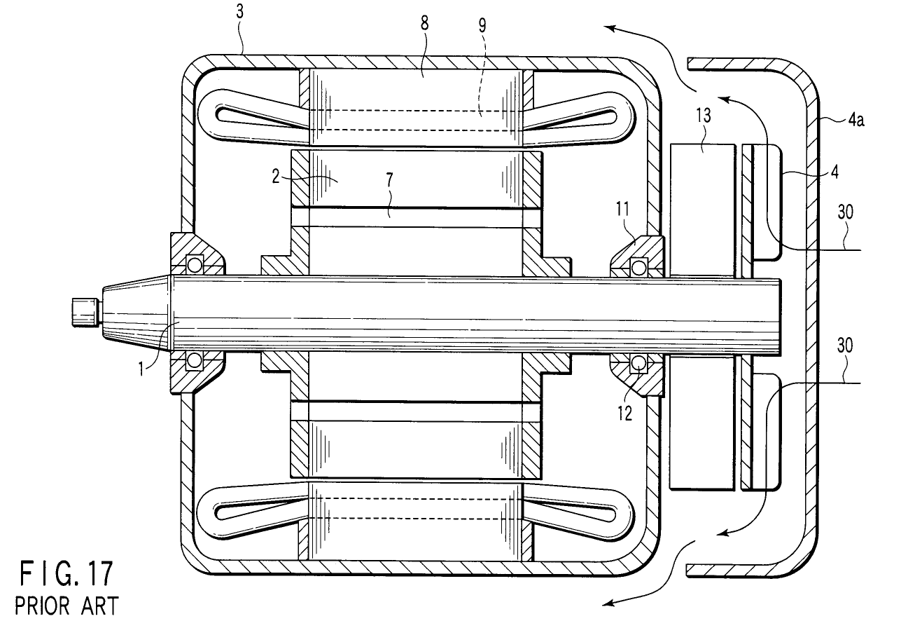

The controller 13 is provided in proximity to the outer periphery of the motor main body 29. Specifically, the controller 13 is installed on one side of the upper part of the motor main body 29. The controller 13 is mounted on a peripheral surface of the frame 3 via supports 14. The controller 13 is connected to the motor main body 29 at three points by the respective supports 14. A ventilating space 6 is provided between the controller 13 and the frame 3. The remaining part of the configuration is similar to that of the motor shown in FIG. 17.

Now, description will be given of the operation of the controller-integrated motor configured as described above.

During the operation of the present controller-integrated motor, rotation of the shaft 1 rotates the outer fan 4. Rotation of the outer fan 4 radially discharges a cooling air stream 30. The discharged cooling air stream 30 has its flow direction changed by the cooling air stream guiding duct 5 from the radial direction to the axial direction of the shaft 1. The cooling air stream 30 then flows in the resulting flow direction and out of the cooling air stream guiding duct 5. The cooling air stream 30 thus flows out of the cooling air stream guiding duct 5 and in the axial direction. The cooling air stream 30 then flows in the axial direction through the ventilating space 6 between the controller 13 and the motor main body 29 and along the outer surface of the motor main body 29. The cooling air stream 30 is then discharged externally.

According to the present embodiment, heat generated by the stator core 8 and stator coil 9 in the motor main body 29 is transferred to the frame 3. The heat transferred to the frame 3 is cooled by the cooling air stream 30 from the outer fan 4, which flows along a surface of the frame 3. The cooling air stream 30 flows along a surface of the controller 13 to increase the thermal conductivity around the controller 13. This enables the controller 13 to be efficiently cooled. This effect makes it possible to inhibit a possible temperature rise in the motor main body 29 and controller 13.

### Second Embodiment

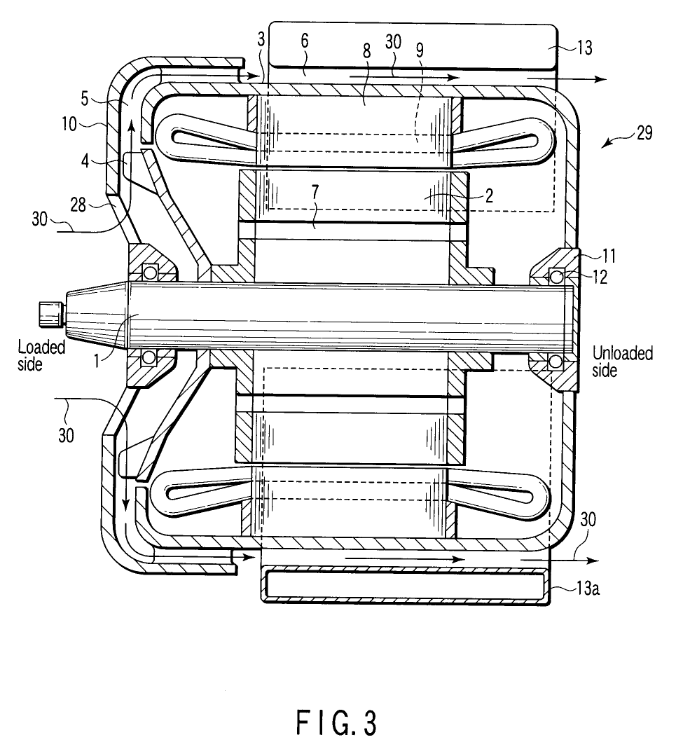

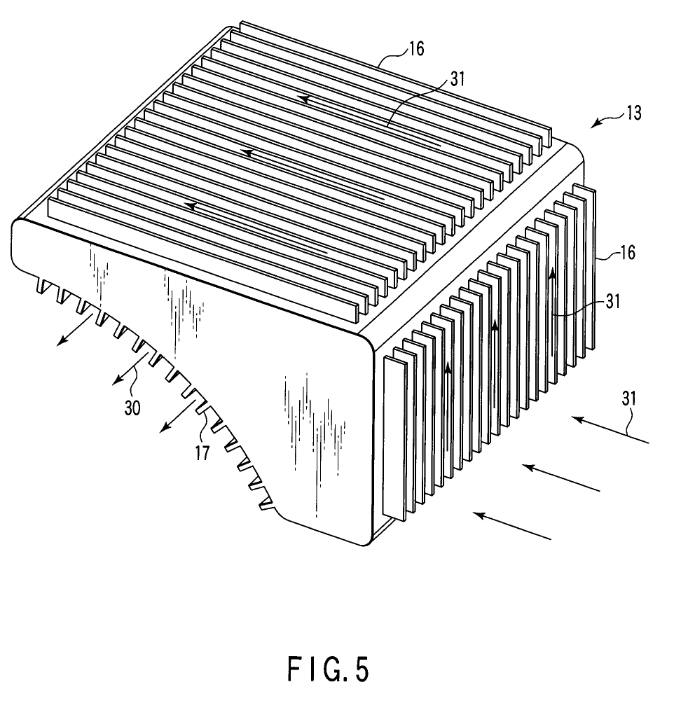

FIG. 3 is a vertical sectional view showing the configuration of a controller-integrated motor in accordance with a second embodiment of the present invention. FIG. 4 is a sectional view showing the configuration of an unloaded side of the controller-integrated motor in accordance with the second embodiment of the present invention.

An upper controller 13 and a lower controller 13a are installed in the present controller-integrated motor. An electric circuit in the controller 13 is connected to an electric circuit in the controller 13a. The connected electric circuits in the controllers 13 and 13a function as one controller. The controller comprising the combination of the controllers 13 and 13a controls the motor main body 29. The remaining part of the configuration is the same as that of the first embodiment.

The flow of the cooling air stream 30 in the present controller-integrated motor is similar to that in the first embodiment. Accordingly, the cooling air stream 30 flows around the plurality of controllers 13 and 13a.

According to the present embodiment, the present controller-integrated motor has the plurality of controllers provided in proximity to the periphery of the motor main body 29. This enables an increase in the thermal conductivity of the surface of the controller. This further improves the cooling performance of the present controller-integrated motor.

### Third Embodiment

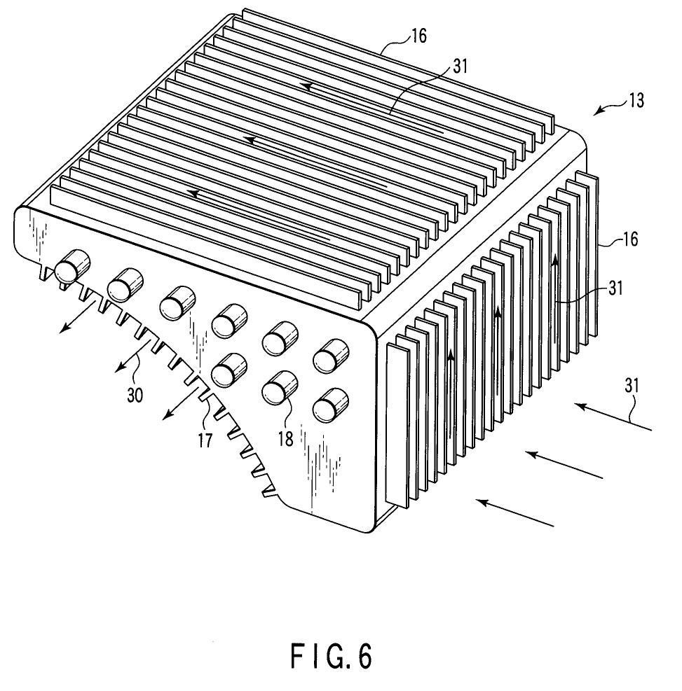

FIG. 5 is a perspective view showing the configuration of a controller provided in a controller-integrated motor in accordance with a third embodiment of the present invention.

The controller-integrated motor in accordance with the present embodiment is configured similarly to those in accordance with the first and second embodiments except for the controller.

The present controller-integrated motor has traveling air stream radiation fins 16 and cooling air stream radiation fins 17 on the surface of the controller 13.

The traveling air stream radiation fins 16 are installed laterally to the motor main body 29 (perpendicularly to the shaft 1) so as to allow a traveling air stream 31 resulting from the motion of the vehicle to flow smoothly. The traveling air stream radiation fins 16 are preferably long but do not interfere with the other components located around the motor main body 29.

The cooling air stream radiation fins 17 are installed in a vertical direction (parallel to the shaft 1) so as to allow the cooling air stream 30 from the outer fan 4 to flow smoothly. The fin height of the cooling air stream radiation fins 17 depends on the distance between the controller 13 and the motor main body 29.

The fin pitch of the traveling air stream radiation fins 16 and cooling air stream radiation fins 17 is set at least 5 mm so as to prevent dirt from being filled between the fins.

According to the present embodiment, the cooling air stream 30 from the outer fan 4 flows among the cooling air stream radiation fins 17. During operation, the traveling air stream 31 resulting from the motion of a railway vehicle flows among the traveling air stream radiation fins 16. This enables an increase in the thermal conductivity of the surface of the controller 13. This makes it possible to improve the cooling performance of the present controller-integrated motor.

### Fourth Embodiment

FIG. 6 is a perspective view showing the configuration of a controller provided in a controller-integrated motor in accordance with a fourth embodiment of the present invention. The configuration of this controller-integrated motor except for the controller is similar to those of the first and second embodiments.

The controller 13 in accordance with the present embodiment has a plurality of heat pipes 18 extending from a housing to the interior of the controller 13. The heat pipes 18 are provided in the axial direction of the shaft 1. The remaining part of the configuration is similar to that of the controller 13 in accordance with the third embodiment.

According to the present embodiment, heat generated in the controller 13 moves an operating fluid in the heat pipes 18. This allows heat generated in the controller 13 to be transported to the entire housing of the controller 13. As a result, heat spots in the controller 13 are relaxed. That is, heat is transferred to the entire housing of the controller 13, exerting the same effect as that of an increased radiation area.

Therefore, in addition to achieving operations and effects in accordance with the third embodiment, the fourth embodiment enables the cooling performance of the controller 13 to be improved.

### Fifth Embodiment

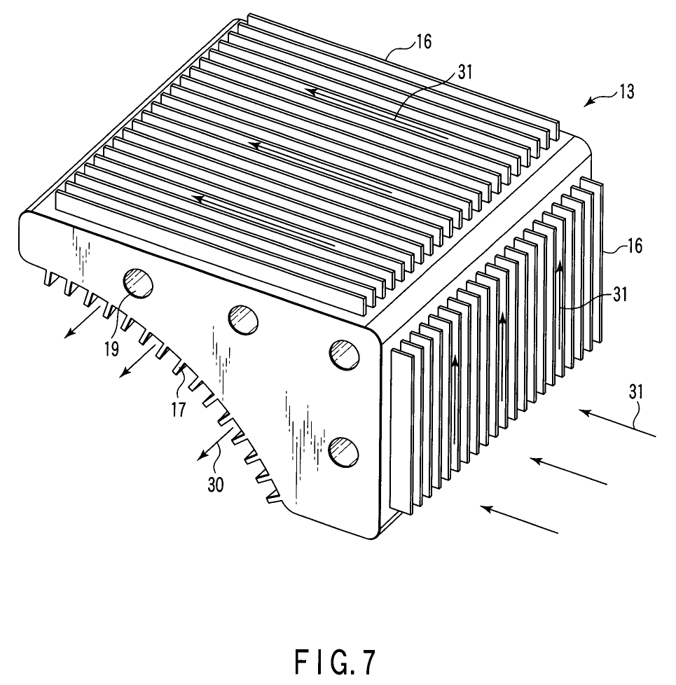

FIG. 7 is a perspective view showing the configuration of a controller of a controller-integrated motor in accordance with a fifth embodiment of the present invention. The configuration of the fifth embodiment is similar to those of the first and second embodiments except for the controller.

The controller 13 in accordance with the present embodiment has a plurality of controller ducts 19 extending in the vertical direction of the controller 13 (parallel to the shaft 1). The number of the controller ducts 19 is determined by a trade-off with the components installed inside the controller 13. The inner diameter of the controller ducts 19 is determined by a trade-off with the area in the controller 13 where the space can be occupied. Too small a diameter of the controller duct 19 increases a pressure loss in the air stream passing through the duct 19. Thus, the controller duct 19 has an inner diameter of at least 10 mm. In the other respects, the controller 13 is configured similarly to that in accordance with the third embodiment.

According to the present embodiment, the cooling air stream 30 flowing out of the cooling air stream guiding duct 5 passes through the controller ducts 19 and is then discharged to the air. In passing through the controller ducts 19, the cooling air stream 30 draws and externally discharges heat generated in the controller 13.

Therefore, in addition to achieving operations and effects in accordance with the third embodiment, the fifth embodiment enables the cooling performance of the controller 13 to be improved.

### Sixth Embodiment

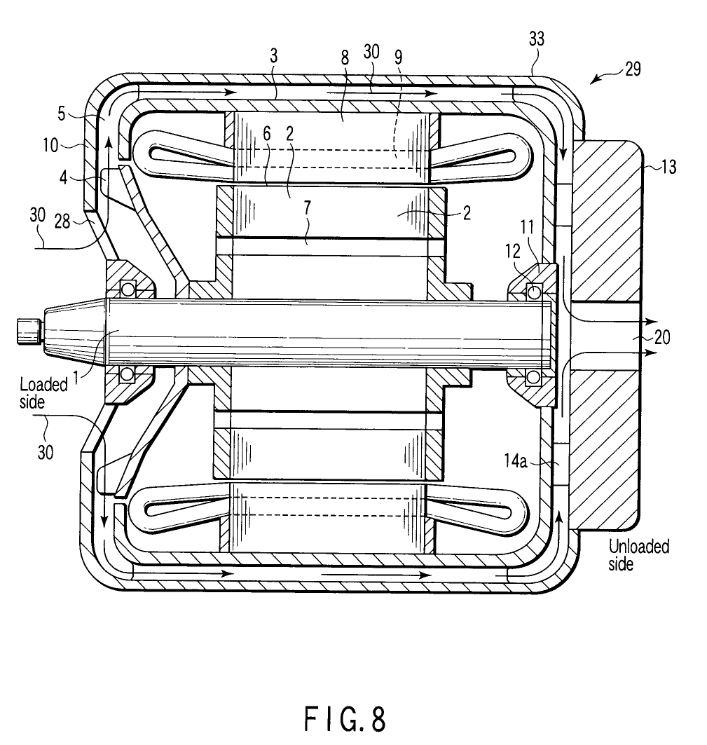

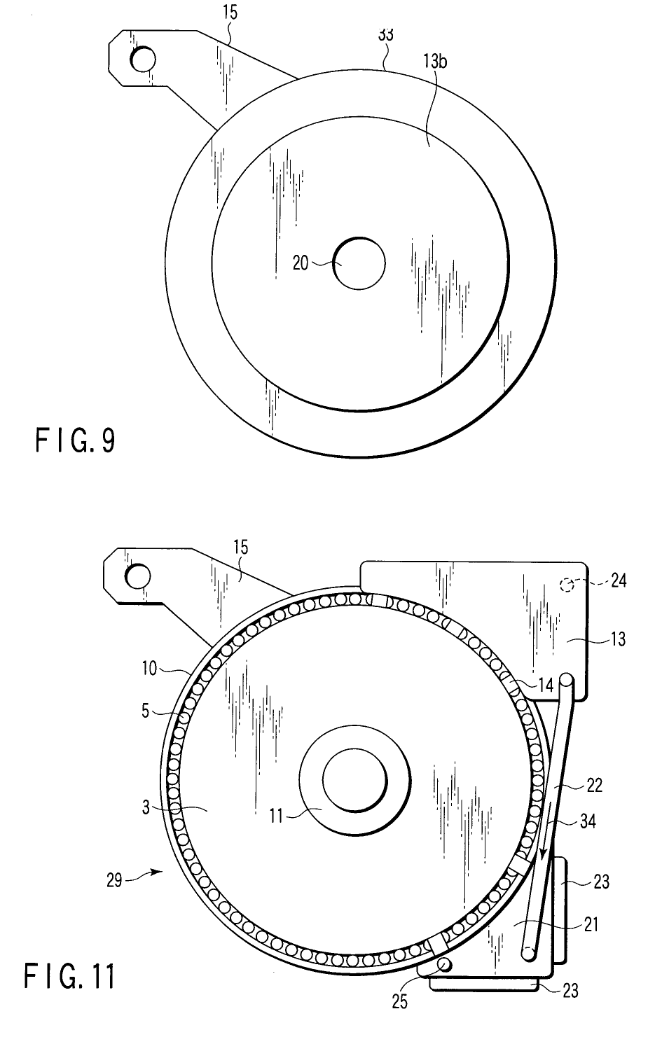

FIG. 8 is a vertical sectional view showing the configuration of a controller-integrated motor in accordance with a sixth embodiment of the present invention. FIG. 9 is a sectional view of an unloaded side of the controller-integrated motor in accordance with the sixth embodiment of the present invention.

The present controller-integrated motor has an outer shell 33 provided outside the frame 3 and which is continuous with the end plate 10. The outer shell 33 allows the cooling air stream guiding duct 5 to extend to the unloaded side. A controller 13b is installed on the unloaded side.

The controller 13b is circular. A controller ventilation duct 20 is provided in the center of the controller 13b. Supports 14a are provided between the controller 13b and the motor main body 29. The supports 14a support the controller 13b. The supports 14a are metal pieces. Four to eight supports 14a are evenly distributed between the side of the frame 3 and the controller 13b. The remaining part of the configuration is similar to that of the first embodiment.

Now, description will be given of the operation of the controller-integrated motor configured as described above.

The cooling air stream 30 is carried from the outer fan 4 through the cooling air stream guiding duct 5 to the unloaded side. On the unloaded side, the cooling air stream 30 is made to flow in the radial direction. The cooling air stream 30 made to flow in the radial direction passes between the controller 13b and the unloaded-side side surface of the motor main body 29. The cooling air stream 30 subsequently passes through the controller ventilation duct 20, provided in the controller 13b, and is then discharged externally.

According to the present embodiment, the motor installation space allows the cooling air stream 30 to be forcibly discharged to the controller 13b even if the controller 13b is installed on the unloaded side. This makes it possible to inhibit a temperature rise in the controller 13b. The present embodiment also allows the outer fan 4, provided in the motor, to discharge the cooling air 30 to the controller 13b, which is thus cooled. Therefore, unlike the controller-integrated motor shown in FIG. 17, the present controller-integrated motor allows the controller 13b to be installed without substantially increasing its length in the axial direction.

### Seventh Embodiment

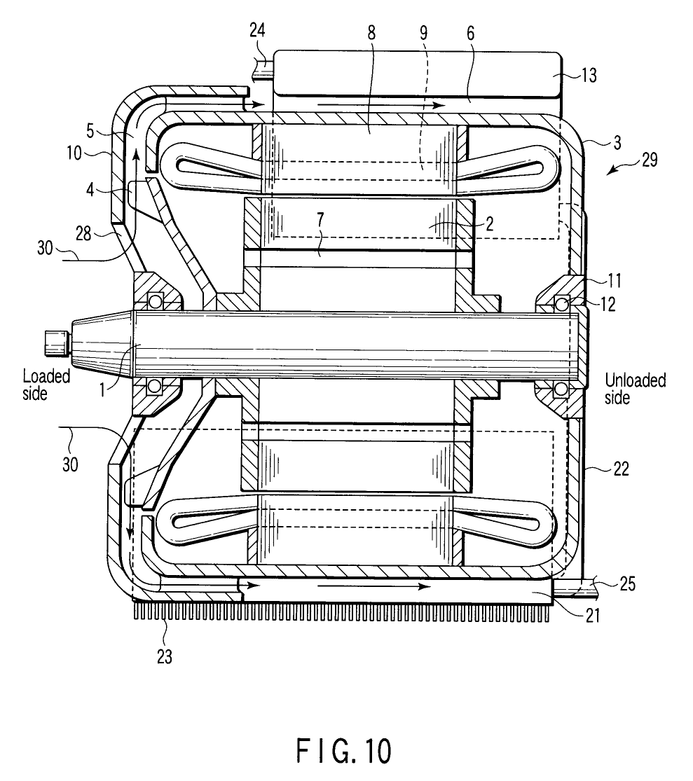

FIG. 10 is a vertical sectional view showing the configuration of a controller-integrated motor in accordance with a seventh embodiment of the present invention. FIG. 11 is a sectional view of an unloaded side of the controller-integrated motor in accordance with the seventh embodiment of the present invention.

In the present controller-integrated motor, the controller 13 is provided in proximity to the outer periphery of the motor main body 29 as is the case with the first and second embodiments. The controller 13 is provided above the motor main body 29.

A liquid entry pipe 24 is connected to an end surface of the controller 13 to supply a cooling liquid 34. A cooling pipe is installed in the controller 13. The cooling pipe is joined to a circulation pipe 22 connected to the other end surface of the controller 13.

The circulation pipe 22 is connected to a radiator 21 provided at the bottom of the motor main body 29.

The radiator 21 has radiator radiation fins 23. The radiator radiation fins 23 are provided on a surface of the radiator 21 which is located opposite the motor main body 29. A liquid exit pipe 25 is connected to an end surface of the radiator 21. A cooling pipe is installed inside the radiator 21 in order to increase radiation efficiency.

The tip of the liquid exit pipe 25 is connected to a circulating pump or a magnetic coupling circulation pump utilizing the rotation of the shaft 1 (not shown). The circulation pump is connected to the liquid entry pipe 24.

The above configuration allows the cooling liquid 34 to flow through the cooling pipe in the controller 13 and radiator 21.

Now, description will be given of the operation of the controller-integrated motor configured as described above.

The cooling liquid 34 flowing through the liquid entry pipe 24 into the controller 13 removes heat generated in the controller 13. The heated cooling liquid 34 is carried to the radiator 21 through the circulation pipe 22. The heated cooling liquid 34 is cooled in the radiator 21. The cooled cooling liquid 34 is discharged from the liquid exit pipe 25. The cooling liquid 34 is subsequently carried to the circulation or magnetic coupling circulation pump (not shown). The cooling liquid 34 is then transported from the circulation pump to the liquid entry pipe 24. Further, the cooling air stream 30 from the outer fan 4 is forcibly discharged to the periphery of the controller 13 and radiator 21. Moreover, a train traveling air stream flows to the periphery of the controller 13 and radiator 21.

According to the present embodiment, the controller 13 is subjected to cooling provided by the cooling air stream 30 from the outer fan 4, the train traveling air stream, and the cooling liquid 34. The cooling results in a high cooling performance. Further, when the heated cooling liquid 34 is cooled by the radiator 21, the cooling air stream 30 from the outer fan 4 and the train traveling air stream also serve to radiate heat. This enables the radiator 21 to efficiently emit heat to the exterior.

### Eighth Embodiment

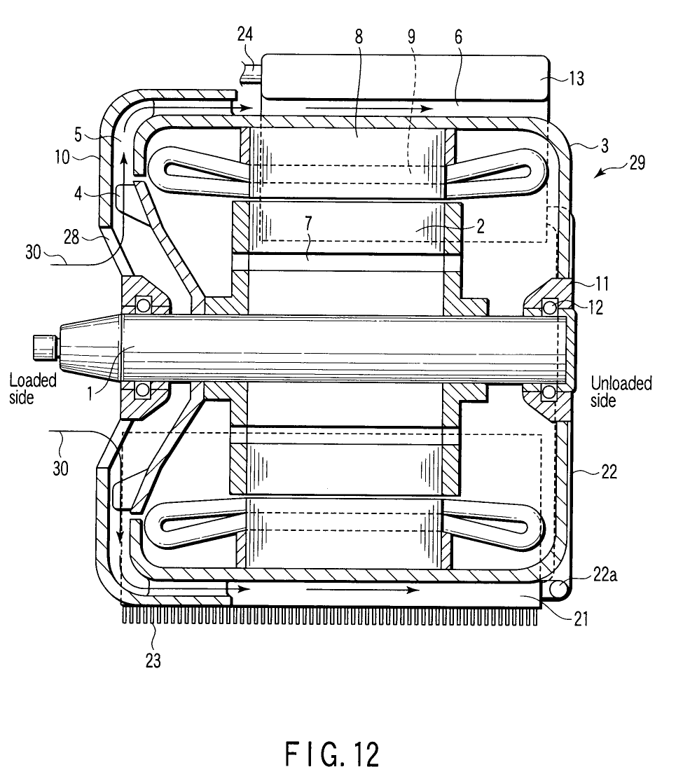

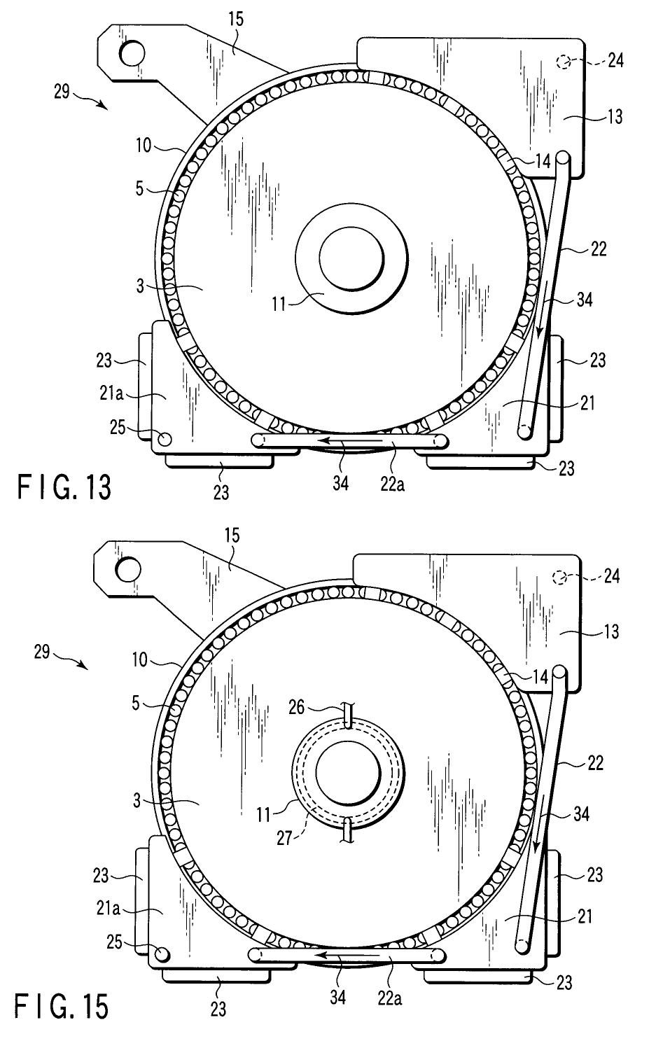

FIG. 12 is a vertical sectional view showing the configuration of a controller-integrated motor in accordance with an eighth embodiment of the present invention. FIG. 13 is a sectional view of an unloaded side of the controller-integrated motor in accordance with the eighth embodiment of the present invention.

Two radiators 21 and 21a are provided under the motor main body 29. The radiators 21 and 21a are connected together by a circulation pipe 22a. The remaining part of the configuration is the same as that of the seventh embodiment.

Now, description will be given of the operation of the controller-integrated motor configured as described above.

The cooling liquid 34 flowing through the liquid entry pipe 24 into the controller 13 removes heat generated in the controller 13. The heated cooling liquid 34 flows to the radiator 21 through the circulation pipe 22. The cooling liquid 34 is then cooled in the radiator 21. The cooling liquid 34 cooled in the radiator 21 is carried to the other radiator 21a through the circulation pipe 22a. The cooling liquid 34 is cooled in the radiator 21a. The cooling liquid 34 cooled in the radiator 21a is discharged from the liquid exit pipe 25. The cooling liquid 34 discharged from the liquid exit pipe 25 is carried to the circulation pump or magnetic coupling-based circulation pump (not shown). The carried-in cooling liquid 34 is transported from the circulation pump to the liquid entry pipe 24. The remaining part of the operation is similar to that of the seventh embodiment.

According to the present embodiment, the controller 13 is subjected to cooling provided by the cooling air stream 30 from the outer fan 4, the train traveling air stream, and the cooling liquid 34. Consequently, the controller 13 is very efficiently cooled. The radiators 21 and 21a are subjected to heat radiation provided by the cooling air stream 30 from the outer fan 4 and the train traveling air stream. Thus, even in cooling the heated cooling liquid 34, the radiators 21 and 21a can efficiently discharge heat externally. The plurality of radiators serve to improve the heat radiating performance. This enables a further reduction in the temperature of the cooling liquid 34. Therefore, the controller 13 can be efficiently cooled.

### Ninth Embodiment

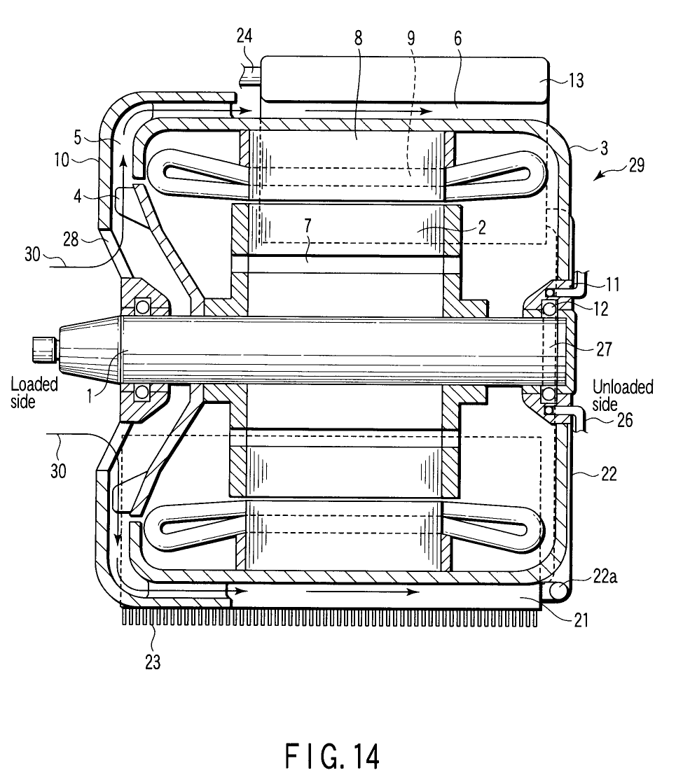

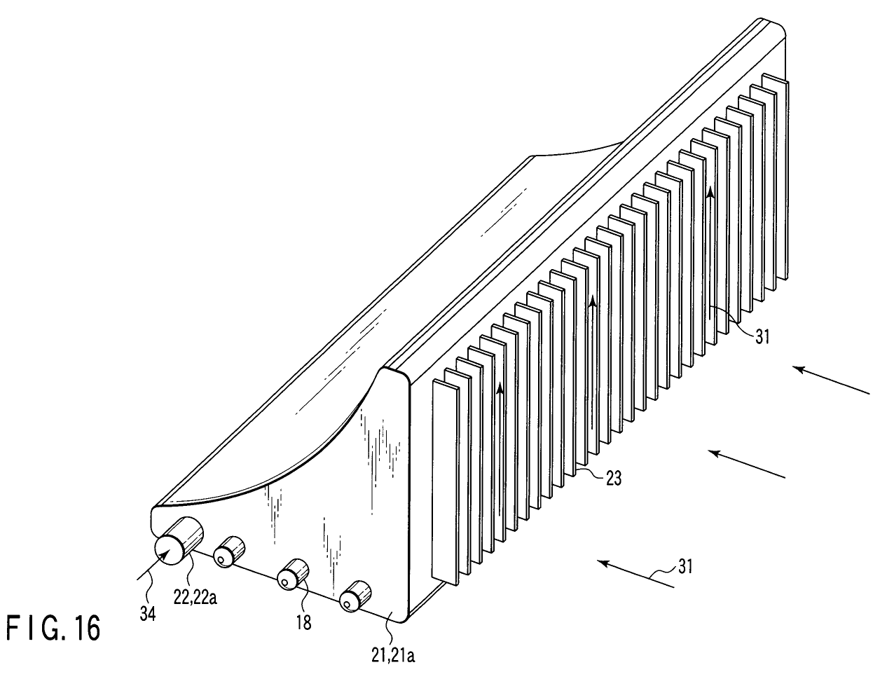

FIG. 14 is a vertical sectional view showing the configuration of a controller-integrated motor in accordance with a ninth embodiment of the present invention. FIG. 15 is a sectional view of an unloaded side of the controller-integrated motor in accordance with the ninth embodiment of the present invention.

The present controller-integrated motor has two bearing cooling liquid transportation pipes 26 and a housing duct 27. The remaining part of the configuration is the same as that of the eighth embodiment.

The bearing cooling liquid transportation pipe 26 is connected to a bearing housing 11 on the unloaded side. The housing duct 27 is provided around the outer periphery of a bearing 12 on the unloaded side. The bearing cooling liquid transportation pipes 26 are provided at an inlet and an outlet, respectively, of the housing duct 27.

The two bearing cooling liquid transportation pipe 26 are installed at the top and bottom, respectively, of the bearing housing 11. In connection with gravity, the bearing cooling liquid transportation pipe 26 installed at the top of the bearing housing 11 serves as the inlet. The bearing cooling liquid transportation pipe 26 installed at the bottom of the bearing housing 11 serves as the outlet.

The housing duct 27 is configured to be circular. The cooling liquid 34 flowing from the inlet diverts to two directions. The diverted flows of the cooling liquid 34 subsequently unite.

The inlet-side tip of the bearing cooling liquid transportation pipe 26 is connected to the circulation pump or magnetic coupling circulation pump (not shown). The outlet-side tip of the bearing cooling liquid transportation pipe 26 is connected to the radiator 21 through the circulation pump 22 (not shown).

Now, description will be given of the operation of the controller-integrated motor configured as described above.

The cooling liquid 34 is fed by the circulation pump or magnetic coupling circulation pump (not shown). The cooling liquid 34 flows through the inlet-side bearing cooling liquid transportation pipe 26 into the housing duct 27. In the housing duct 27, the cooling liquid 34 uniformly diverts in two directions. Subsequently, the diverted flows of the cooling liquid 34 unite again and flow to the outlet-side bearing cooling liquid transportation pipe 26. The cooling liquid 34 flowing out of the bearing cooling liquid transportation pipe 26 flows through a circulation pipe (not shown) into the radiator 21. The remaining part of the operation is similar to that of the eighth embodiment.

According to the present embodiment, part of the cooling liquid 34 flows into the bearing housing 11 on the unloaded side to enable sufficient cooling of a bearing with a low temperature rise limit value. The present embodiment can also inhibit a possible temperature rise in the unloaded-side bearing in a motor of a type that cannot efficiently utilize the air.

### Tenth Embodiment

FIG. 16 is a perspective view showing the configuration of a radiator provided in a controller-integrated motor in accordance with a tenth embodiment of the present invention.

The present controller-integrated motor has a plurality of heat pipes 18 in each of the radiators 21 and 21a, shown in FIGS. 10 to 15. The heat pipes 18 are provided at the bottom of each of the radiators 21 and 21a. Here, the positions and the number of the heat pipes 18 depend on the internal size of each of the radiators 21 and 21a.

According to the present embodiment, the heat pipes 18 provided in each of the radiators 21 and 21a allows heat generated in the in the radiator to be uniformly transferred to its housing. This improves the heat balances in each of the radiators 21 and 21a, increasing heat radiation efficiency. This allows the radiators 21 and 21a to further reduce the temperature of the cooling liquid 34, enabling a further reduction in the temperature rise in the controller 13 and bearing housing 11, where the cooling liquid 34 circulates.

In the first embodiment, the outer periphery of the end plate 10 covering the frame 3 may be extended in the axial direction so that a cooling air stream flows throughout the controller 13. Further, the controller 13 is installed on one side of the top of the motor main body 29, but the present invention is not limited to this. For example, the end plate 10 may be installed under the motor main body 29. In this case, the end plate 10 is positioned and sized so as not to interfere with wheel shafts or any other components in the bogie. Furthermore, the controller 13 is connected to the motor main body 29 at the three points via the respective supports. However, the present invention is not limited to this. Any number of supports 14 may be used provided that the controller 13 can be supported. The supports 14 may be composed of elastic members such as springs or rubber instead of metal pieces. If almost no space is present between the controller 13 and the motor main body 29 or the controller 13 and the motor main body 29 are installed in tight contact with each other, no supports 14 need to be used.

In the controller-integrated motor in accordance with the second embodiment, the two controllers are distributively provided at the top and bottom, respectively, of the motor so that they can be connected together. The controller has only to be divided in a plurality of pieces. The other structural constraints are similar to those in the first embodiment. Moreover, the shape of the controller is not particularly limited.

The third embodiment describes the controller 13 shown in FIGS. 1 to 4. When configured similarly to that of the controller 13, the controller 13a shown in FIGS. 3 and 4 can exert effects similar to those of the controller 13. The controller 13 may have fins on the opposite side surfaces which have a length posing no dimensional problem.

In the fourth embodiment, the heat pipes 18 are provided in the axial direction of the shaft 1. However, the heat pipes 18 may be installed in the lateral direction (perpendicularly to the shaft). The number of heat pipes 18 installed may be optionally determined on the basis of a trade-off with the components installed inside the controller. The fourth embodiment describes the controller 13 shown in FIGS. 1 to 4. When configured similarly to that of the controller 13, the controller 13a shown in FIGS. 3 and 4 can exert effects similar to those of the controller 13.

In the fifth embodiment, the controller ducts 19 are provided in the vertical direction. However, the controller ducts 19 may be provided in the lateral direction. In this case, the traveling air stream 31 passes through the controller ducts 19 and is then discharged externally. In passing through the controller ducts 19, the traveling air stream 31 draws and externally discharges heat generated in the controller 13. This makes it possible to further improve the cooling performance of the controller 13.

In the fifth embodiment, the number of controller ducts 19 installed may be optionally determined on the basis of a trade-off with the components installed in the controller 13. The inner diameter of the controller ducts 19 may be optionally determined on the basis of a trade-off with the area in the controller 13 where the space can be occupied. The controller ducts 19 preferably have a large inner diameter. The fifth embodiment describes the controller 13 shown in FIGS. 1 to 4. When configured similarly to that of the controller 13, the controller 13a shown in FIGS. 3 and 4 can exert effects similar to those of the controller 13.

In the sixth embodiment, the controller 13b is circular. However, the controller 13b may be polygonal or may have any other shape. The controller ventilation dust 20 is provided in the center of the controller 13b. However, the present invention is not limited to this. The controller ventilation duct 20 has only to be configured so that the cooling air stream 30 is externally discharged via the controller 13b. Moreover, the supports 14a may be composed of rubber or springs instead of metal pieces.

In the seventh embodiment, if a magnetic coupling circulation pump (not shown) is used as a circulating pump, the liquid entry pipe 24 and the liquid exit pipe 25 are not required. Further, in the seventh embodiment, the controller 13 is provided at the top of the motor main body 29, and the radiator 21 is provided at the bottom of the motor main body 29. However, the present invention is not limited to this configuration. The controller 13 and the radiator 21 may be located in an unoccupied space. If the controller 13 and the radiator 21 are located adjacent to each other, the circulation pipe 22 need not be used. Further, the radiation fins 23 may be provided on the motor main body 29 like the cooling air stream radiation fins 17 in accordance with the third to fifth embodiments (FIGS. 5 to 7).

In the eighth embodiment, more radiators may be installed if they pose no spatial problem. The circulation pipe 22a is not required when the radiators 21 and 21a are installed adjacent to each other or so as to have an integrated shape. Changes may be made to the configuration of the radiators 21 and 21a and the circulation pipes 22 and 22a, through which the cooling liquid 34 circulates in this order. These configurations have only to allow the cooling liquid 34 to circulate efficiently through the radiators ad pipes.

In the tenth embodiment, the positions and the number of the heat pipes 18 may be optically varied depending on the internal sizes of the radiators 21 and 21a and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A controller-integrated motor comprising:
a motor main body and a controller integrated with the motor main body to control the motor main body,
the motor main body including:
a stator core;
a shaft which rotates to exert driving force on the motor main body;
a frame which holds the stator core and the shaft; and
an outer fan provided around the shaft so that the motor main body is recessed inward toward a rotational center of the shaft, the outer fan discharging cooling air stream to cool the motor main body,
the controller being provided in proximity to an outer periphery of the frame,
the motor main body being formed so that a cooling air stream from the outer fan flows in an axial direction of the shaft along an outer peripheral surface of the frame.

2. A controller-integrated motor comprising:
a motor main body and a controller integrated with the motor main body to control the motor main body,
the motor main body including:
a stator core;
a shaft which rotates to exert driving force on the motor main body;
a frame which holds the stator core and the shaft; and
an outer fan provided around the shaft so that the motor main body is recessed inward toward a rotational center of the shaft, the outer fan discharging a cooling air stream to cool the motor main body,
the controller being provided on an outer periphery of the frame,
the motor main body being formed so that a cooling air stream from the outer fan flows in an axial direction of the shaft along an outer peripheral surface of the frame.

3. A controller-integrated motor comprising:
a motor main body and a controller integrated with the motor main body to control the motor main body,
the motor main body including:
a stator core;
a shaft which rotates to exert driving force on the motor main body;
a frame which holds the stator core and the shaft; and
an outer fan provided around the shaft so that the motor main body is recessed inward toward a rotational center of the shaft, the outer fan discharging a cooling air stream to cool the motor main body, wherein
the controller is provided on a side surface of the frame which is opposite to the outer fan in an axial direction of the shaft, and which
further comprises a duct provided on a peripheral surface of the frame to guide a cooling air stream from the outer fan along an outer peripheral surface of the frame to the controller.

4. The controller-integrated motor according to any of claims 1 to 3, wherein the controller comprises radiation fins for radiation.

5. The controller-integrated motor according to any of claims 1 to 3, wherein the controller comprises a heat pipe for radiation.

6. The controller-integrated motor according to any of claims 1 to 3, wherein the controller comprises a penetration duct penetrating the controller for radiation.

7. The controller-integrated motor according to any of claims 1 to 3, further comprising:
a cooling liquid circulation pipe installed in the controller to circulate a cooling liquid for cooling the controller; and
a radiator connected to the cooling liquid circulation pipe so as to allow the cooling liquid to flow from the cooling liquid circulation pipe into the radiator, the radiator cooling the cooling liquid.

8. The controller-integrated motor according to any of claims 1 to 3, further comprising:
a cooling liquid circulation pipe installed in the controller to circulate a cooling liquid for cooling the controller;
a radiator connected to the cooling liquid circulation pipe so as to allow the cooling liquid to flow from the cooling liquid circulation pipe into the radiator, the radiator cooling the cooling liquid; and
radiation fins provided on the radiator to radiate heat from the radiator.

9. The controller-integrated motor according to any of claims 1 to 3, further comprising:
a housing duct which allows a cooling liquid to flow into a housing for a bearing supporting the shaft, the cooling liquid cooling the bearing; and
a radiator connected to the housing duct so as to allow the cooling liquid to flow into the radiator, the radiator cooling the cooling liquid.

10. The controller-integrated motor according to any of claims 1 to 3, further comprising:
a cooling liquid circulation pipe installed in the controller to circulate a cooling liquid for cooling the controller;
a housing duct connected to the cooling liquid circulation pipe so as to allow the cooling liquid to flow through the housing duct, the housing duct allowing a cooling liquid to flow into a housing for a bearing supporting the shaft, the cooling liquid cooling the bearing; and
a radiator which cools the cooling liquid having flowed through the cooling liquid circulation pipe and the housing duct.

11. The controller-integrated motor according to any of claims 1 to 3, further comprising:
a cooling liquid circulation pipe installed in the controller to circulate a cooling liquid for cooling the controller;
a housing duct connected to the cooling liquid circulation pipe so as to allow the cooling liquid to flow through the housing duct, the housing duct allowing a cooling liquid to flow into a housing for a bearing supporting the shaft, the cooling liquid cooling the bearing;
a radiator which cools the cooling liquid having flowed through the cooling liquid circulation pipe and the housing duct; and
radiation fins provided on the radiator to radiate heat from the radiator.
